(19) United States
(12) Patent Application Publication
(10) Pub. No.: US 2006/0111223 A1
(43) Pub. Date: May 25, 2006

(54) Etched type inkjet printer roller

(76) Inventor: Chih-Huang Chou, Taipei Hsien (TW)

Correspondence Address: Chih-Huang CHOU, P.O. Box No. 6-57, Junghe, Taipei 235, TW

(21) Appl. No.: 10/994,393

(22) Filed: Nov. 23, 2004

(51) Int. Cl. A01B 29/00

(52) U.S. Cl. 492/37; 492/30

(57) ABSTRACT

An etched type inkjet printer roller embodying a frictional surface that actuates conveying of paper sheets that is configured on a surface of the roller possessing standard precisions. The frictional surface is configured by employing etching technology that actualizes etch points below the standard precision surface, and which effectively preserves original degrees of precision possessed by the roller, thereby realizing convenience in manufacture of the roller, and ensuring requisite degrees of precision. The present invention improves upon shortcomings of current roller manufacturing processes that impair degrees of precision of the roller, creates enhanced effectiveness in functional practicability, and is a new model having practical value.

### BACKGROUND OF THE INVENTION

(a) Field of the Invention

The present invention relates to an etched type inkjet printer roller, and more particularly to the etched type inkjet printer roller provided with a frictional surface, and because etching method employed results in etch points that are below the surface of the roller, thus a structural body so configured preserves original degrees of precision possessed by the surface of the roller, which not only realizes convenient manufacture of the roller, moreover, achieves superior friction and degrees of precision for the surface of the roller, with the result that the roller is provided with functional practicability.

(b) Description of the Prior Art

A roller as utilized in a conventional ink jet printer is necessarily provided with a surface having substantial friction in order to actuate conveying of paper sheets, moreover, the roller possesses precision standards in degree of roundness and degree of skew. Thus, a structural body is provided with a plastic elastic (pliable) cylindrical body (b) molded on an exterior of a metal roller axis (a) in order to provide the roller with the surface having substantial friction, as depicted in the cross-sectional view of FIG. 1. However, although the integral molded plastic elastic (pliable) cylindrical body (b) is provided with good frictional force, nevertheless, a joint line (c) is formed when molding, thereby necessitating dependence on machine processing to remove the joint line (c) in order to achieve required degrees of precision. However, presently, regardless of increased high-precision of equipment employed, because of properties of plastic elasticity (pliable), the cylindrical body deforms with temperature, resulting in variability in degrees of precision far greater than a metallic cylindrical body, and is thus unable to achieve the degrees of precision of the metallic cylindrical body. Another structural configuration, wherein exterior of the metal roller axis (a) is similarly complemented with the cylindrical body (b), but of different material, such as metal or ceramic, and so on (see FIG. 2), wherein:

The cylindrical body (b) is fabricated from ceramic material, whereby abrasion proof material (d) mixed with ceramic particles is sprayed onto the metal roller axis (a). However, because of unevenness of coat thickness, different size of ceramic particles, problems related to layering of the ceramic particles, and so on, such shortcomings equally impair the original degrees of precision of the metal roller axis (a). Moreover, because of inability to measure the aforementioned resulting problems, correcting the degrees of precision is even more difficult.

The cylindrical body (b) is fabricated from metallic material, whereby a metal laminate is utilized, and after etching is folded to form a cylindrical shape, whereupon the cylindrical shape is assembled together with the precision metal roller axis (a). However, when folding the etched metal laminate to form the cylindrical shape, the degree of roundness and seam formed on assemblage not only results in difficult processing, moreover, causes impairment to the original degrees of precision of the metal roller axis (a), and thus deviates from practical requirements.

Hence, under structural demands for the roller to possess the requisite surface friction and degrees of precision, necessary budgeting for a relatively larger cost to manufacture current conventional rollers in order to achieve such degrees of precision is apparent. Accordingly, there is a need for an improved structure for a roller in order to enhance functional practicability.

### SUMMARY OF THE INVENTION

In light of aforementioned shortcomings in usage of a structural configuration of a conventional roller, the inventor of the present invention, having accumulated years of experience in related arts, attentively and circumspectly carried out extensive study and exploration to ultimately design a completely new structure for an etched type inkjet printer roller. The present invention provides for conveniently achieving requisite friction and degrees of precision for a surface of the roller. A primary objective of the present invention is to provide a non-plastic cylindrical body for the roller that realizes relatively easy control of the required degrees of precision of the roller during manufacture. Furthermore, an etching technique is carried out on the surface of the cylindrical body of the roller under conditions that preserve the degrees of precision, and utilizing uniformly distributed etch points directed below the surface not only preserves the original degrees of precision possessed by the cylindrical body of the roller, moreover, because the etching technique is implemented on the surface, thus friction of the surface of the cylindrical body of the roller is increased. Hence, the required cylindrical body of the roller is conveniently realized under conditions whereby aforementioned two features are complementarily utilized, and which improves upon manufacturing problems of conventional structures, enhancing functional practicability thereof.

Another objective of the present invention is to employ a printing method to implement etching of the surface of the cylindrical body of the roller, whereby the surface of the cylindrical body of the roller is provided with a plurality of uniformly distributed printing ink areas, whereafter an etching agent as utilized in etching technology is able to conveniently etch the etch points on the surface of the roller and facilitate cleaning after etching is competed, whereby the original plurality of printing ink areas on the surface of the cylindrical body of the roller are conserved, and those areas between the plurality of printing ink areas are etched away, thus forming a non-smooth surface, and effectively increasing friction of the surface.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cross-sectional view of a conventional roller.

FIG. 2 shows a cross-sectional view of another conventional roller.

FIG. 3 shows a schematic elevational view of an embodiment according to the present invention.

FIG. 4A shows a partial enlarged cross-sectional view of an embodiment of a surface of a roller according to the present invention.

FIG. 4B shows another partial enlarged cross-sectional view of the embodiment of the surface of the roller according to the present invention.

FIG. 4C shows yet another partial enlarged cross-sectional view of the embodiment of the surface of the roller according to the present invention.

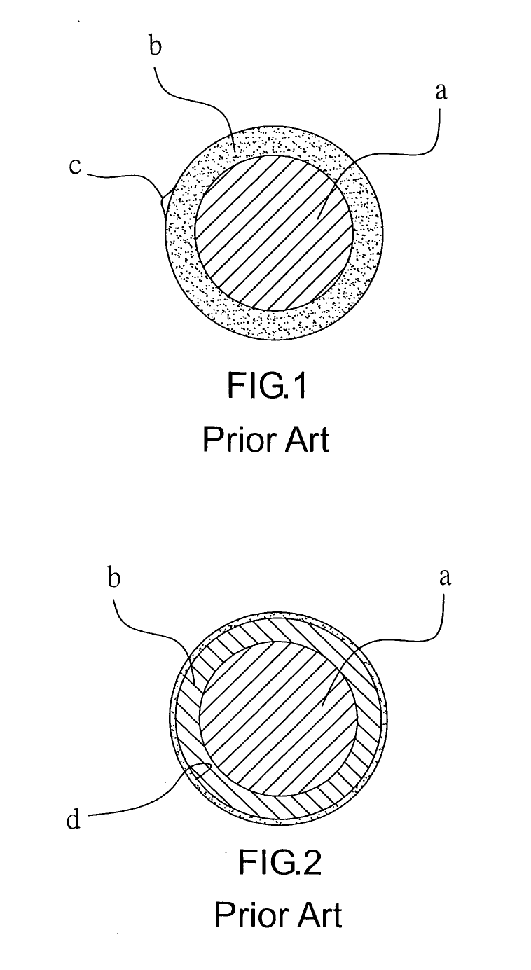

### DETAILED DESCRIPTION OF THE PREFERRED EMBODIMENTS

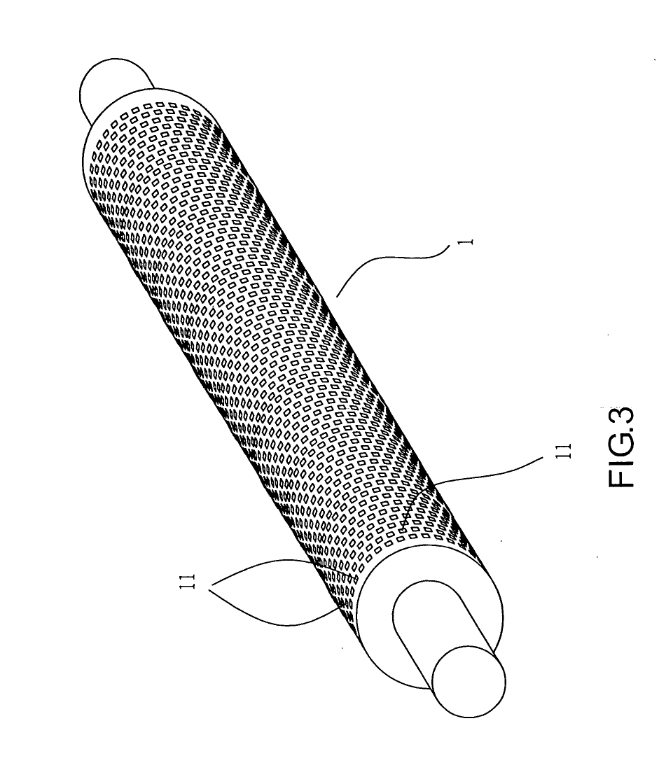

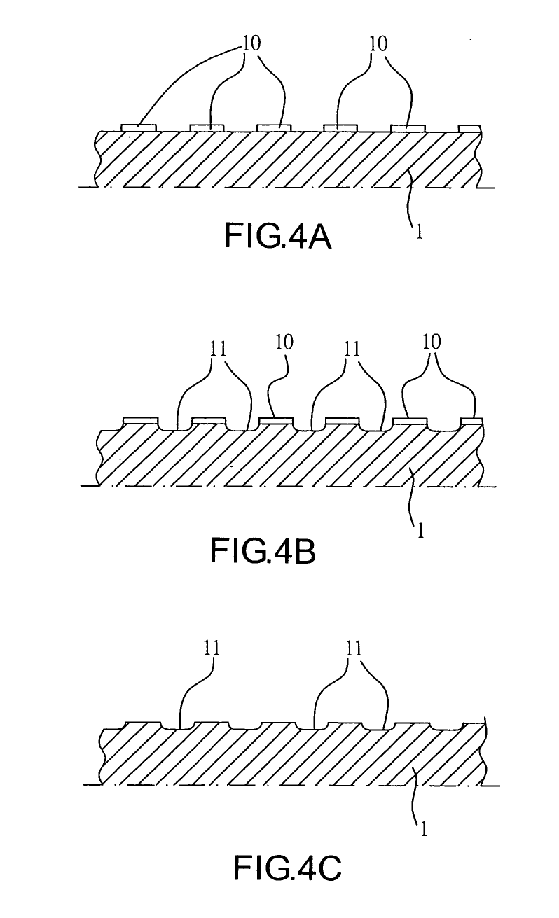

Referring to FIG. 3, which shows a schematic elevational view of an embodiment of the present invention, wherein a roller (1) is a non-plastic body, and requisite standard precisions are achieved during manufacture of a cylindrical body, such as degree of roundness of external diameter of the cylindrical body (tolerance of ±0.011 mms), and degree of skew (0.013 degrees), and so on. Such degrees of precision are established by measurement; accordingly, surface of the roller (1) is smooth when establishing the degrees of precision. However, the smooth surface of the roller (1) needs to possess friction, but without impairing the degrees of precision possessed by the roller (1), and employing a conventional method of covering and spraying a surface layer to fabricate a structural body is already known to create problems. Hence, the present invention adopts a totally different method to fabricate a structural body, namely a plurality of uniformly distributed etch points (11) are configured on the surface of the roller (1), moreover, the etch points (11) are featured below the surface of the roller (1), and thus the standard degrees of precision originally possessed by the cylindrical body of the roller (1) are not effected. On the contrary, the uniform distribution of etch points (11) are utilized to allow forming of a non-smooth surface of the roller (1), thereby creating a good frictional surface, which allows the roller (1) to conveniently achieve necessary requirements for usage. In addition, a mimeograph printing method is employed to actualize the uniform distribution of etch points (11) on the surface of the roller (1), as depicted in FIG. 4A, which shows a partial enlarged cross-sectional view of the surface of the roller (1). Areas printed with printing ink (10) on the surface of the roller (1) are non-etch areas, and the mimeograph printing method is employed to print the printing ink (10) onto the non-etch areas, which thereby forms a uniform and interleaving distribution with the etch points (11), whereupon, an etching agent as utilized in etching technology is able to conveniently etch the etch points (11) on the surface of the roller (1), and realizes etch points (11) that are etched below the surface of the roller (1) (see FIG. 4B), which thus forms the surface of the roller (1) possessing sunken etch points (11), after which the printing ink (10) is cleaned from the surface of the roller (1) with a dissolvent (see FIG. 4C), whereafter the non-etch areas are able to preserve the original standard degrees of precision of the entire cylindrical body of the roller (1). Hence, after application of aforementioned etching technology and processing, the surface of the roller (1) not only possesses reenforced friction, moreover, the original degrees of precision are preserved, which thus totally eliminates the shortcomings created by the conventional structural body, and assuredly effectuates enhancing effectiveness in usage of the roller (1). Accordingly, the present invention actualizes the structural body that embraces extreme practical value.

In conclusion, structural configuration of an etched type inkjet printer roller of the present invention assuredly is a foremost innovation; moreover, contents of the present invention have not been publicly disclosed in any form prior to this application. The present invention has certainly resolved existent structural shortcomings in usage of a conventional roller, and realizes allowing the roller to undergo convenient processing to reenforce friction of the surface, while effectively preserving the original degrees of precision possessed by the roller. Advancement and practicability of the present invention amply comply with essential elements as required for a new patent application, accordingly, a new patent application is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An etched type inkjet printer roller comprising a plurality of uniformly distributed etch points and non-etch areas configured on a surface of a cylindrical body of a roller, moreover, the etch points are featured below the surface of the roller.

2. The etched type inkjet printer roller according to claim 1, wherein the cylindrical body of the roller is fabricated from steel material, moreover, degrees of precision and degree of roundness of surface measurements prior to etching comply with standard precisions of practical requirements, and after etching and processing has been implemented, the degrees of precision and the degree of roundness of the surface are preserved by means of the uniform distribution of non-etch areas.

3. The etched type inkjet printer roller according to claim 1, wherein of the plurality of uniformly distributed etch points and non-etch areas configured on the surface of the roller, a printing method is utilized to print printing ink on the non-etch areas, which thereby forms a uniform and interleaving distribution with the etch points.
